(19) United States
(12) Patent Application Publication
(10) Pub. No.: US 2024/0113550 A1
(43) Pub. Date: Apr. 4, 2024

(54) SOLAR JUMPSTART SYSTEM FOR VEHICLE BATTERY

(71) Applicant: Brianna Siegman, Castroville, CA (US)

(72) Inventor: Brianna Siegman, Castroville, CA (US)

(21) Appl. No.: 17/958,987

(22) Filed: Oct. 3, 2022

(51) Int. Cl. H02J 7/35; B60L 53/51; B60L 53/53; H02J 1/10; H02J 7/34; H02S 10/40; H02S 40/38

(52) U.S. Cl. CPC H02J 7/35; B60L 53/51; B60L 53/53; H02J 1/122; H02J 7/342; H02S 10/40; H02S 40/38

(57) ABSTRACT

A solar jumpstart system for a vehicle is disclosed. The system includes at least one solar panel on the vehicle, where the solar panel is operable to convert light into electricity. The system further includes a battery system that includes a number of batteries operable to store the electricity generated by the solar panel. The batteries include, but not limited to, at least one first battery operable to jumpstart a battery of the vehicle when the battery of the vehicle is depleted or discharged.

### FIELD OF THE INVENTION

Embodiments of the present disclosure relate generally to vehicle jumpstart system. More particularly, embodiments of the invention relate to solar jumpstart system for vehicle battery.

### BACKGROUND

Generally, to jumpstart a motor vehicle (also referred to as a boost), such as a car or truck, that has a discharged or depleted battery, a temporary connection is made to the battery of another vehicle (e.g., another car or truck), or to some other external power source (e.g., a portable emergency starting power supply). The external supply of electricity recharges the disabled vehicle's battery and provides some of the power needed to crank the engine. Once the vehicle has been started, its normal charging system will recharge, so the secondary source can be removed. If the vehicle charging system is functional, leaving the engine running will restore the charge of the battery, although it is usually recommended to drive the vehicle for a few minutes after starting to speed up the recharging process. However, with respect to the former option (temporary connection to another vehicle's battery), one needs to carry jumper cables and other equipment, and find an automobile that is just nearby and meets the connection conditions. As such, the waiting time for rescue can be long. With respect to the latter option (external power source), the need for emergency start-up power is infrequent and if the typical emergency start-up power carried in the vehicle has not been charged within a sufficiently recent timeframe, there can be insufficient stored energy in the portable emergency starting port supply, and therefore, it cannot be used to start the vehicle.

### BRIEF DESCRIPTION OF THE DRAWINGS

Embodiments of the invention are illustrated by way of example and not limitation in the figures of the accompanying drawings in which like references indicate similar elements.

FIG. 1 is a block diagram illustrating an example of a solar jumpstart system for a vehicle battery according one embodiment.

FIG. 2 is a block diagram illustrating another example of the solar jumpstart system according to one embodiment.

FIG. 3 is a block diagram illustrating yet another example of the solar jumpstart system according to one embodiment.

FIG. 4 is a block diagram illustrating an example of a battery system of the solar jumpstart system according to one embodiment.

### DETAILED DESCRIPTION

Various embodiments and aspects of the inventions will be described with reference to details discussed below, and the accompanying drawings will illustrate the various embodiments. The following description and drawings are illustrative of the invention and are not to be construed as limiting the invention. Numerous specific details are described to provide a thorough understanding of various embodiments of the present invention. However, in certain instances, well-known or conventional details are not described in order to provide a concise discussion of embodiments of the present inventions.

Reference in the specification to “one embodiment” or “an embodiment” means that a particular feature, structure, or characteristic described in conjunction with the embodiment can be included in at least one embodiment of the invention. The appearances of the phrase “in one embodiment” in various places in the specification do not necessarily all refer to the same embodiment.

Note that in the corresponding drawings of the embodiments, signals are represented with lines. Some lines may be thicker or have a slash over the lines, to indicate more constituent signal paths, such as a differential signal, and/or have arrows at one or more ends, to indicate primary information flow direction. Such indications are not intended to be limiting. Rather, the lines are used in connection with one or more exemplary embodiments to facilitate easier understanding of a circuit or a logical unit. Any represented signal, as dictated by design needs or preferences, may actually comprise one or more signals that may travel in either direction and may be implemented with any suitable type of signal scheme.

Throughout the specification, and in the claims, the term “connected” means a direct electrical connection between the things that are connected, without any intermediary devices. The term “coupled” means either a direct electrical connection between the things that are connected, or an indirect connection through one or more passive or active intermediary devices. The term “circuit” means one or more passive and/or active components that are arranged to cooperate with one another to provide a desired function. The term “signal” means at least one current signal, voltage signal or data/clock signal. The meaning of “a”, “an”, and “the” include plural references. The meaning of “in” includes “in” and “on”.

According to an aspect of the disclosure, a solar jumpstart system for a vehicle is provided. The system includes at least one solar panel on the vehicle, where the solar panel is operable to convert light into electricity. The system further includes a battery system that includes a number of batteries operable to store the electricity generated by the solar panel. The batteries include, but not limited to, at least one first battery operable to jumpstart a battery of the vehicle when the battery of the vehicle is depleted or discharged.

The batteries may further include, but not limited to, at least one second battery operable to charge electronic devices and small appliances. The first battery and the second battery may be connected in parallel with one another. The first battery may be connected in parallel with the battery of the vehicle.

In an embodiment, the system further includes a solar charge controller operable to connect the solar panel to the battery system, and to regulate voltage and current flow from the solar panel to the batteries of battery system. The solar charge controller may be a pulse width modulation (PWM) charge controller or maximum power point tracking (MPPT) charge controller.

In an embodiment, the batteries further include a battery connected to electronic device charging ports of the vehicle through one or more conductors. The conductors may be fed into a cabin of the vehicle. The conductors may be fed into the cabin of the vehicle through holes located on a roof of the vehicle.

In an embodiment, the first battery is a 12V battery and the second battery is a 6V battery.

In an embodiment, the battery system further includes universal serial bus (USB) ports to charge or power electronic devices. The battery system may further include an AC power outlet operable as a charging or power station. The battery system may further include a display displaying a voltage of the battery system. The display may include a battery level indicator visually indicating state of charge of the battery system. The battery system may further include a jumpstart indicator indicating whether the jumpstart of the battery of the vehicle is available.

In an embodiment, the first battery only performs the jumpstart of the battery of the vehicle when the first battery is fully charged by the solar panel.

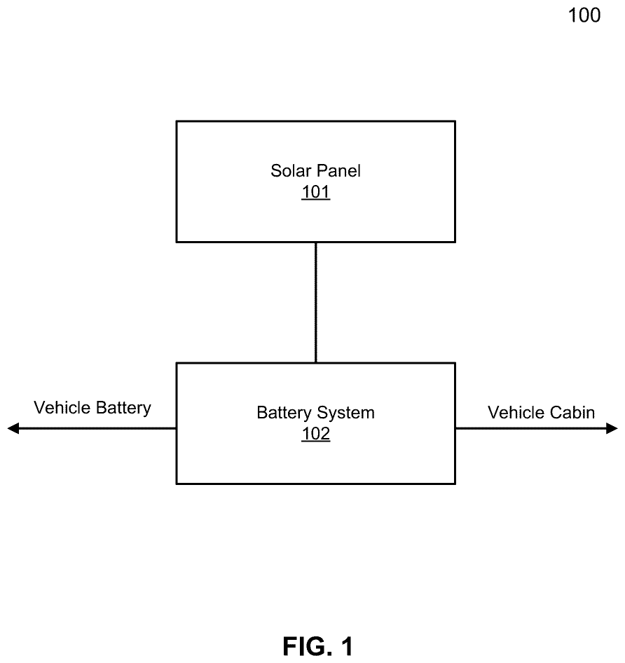

FIG. 1 is a block diagram illustrating an example of a solar jumpstart system for a vehicle battery according one embodiment. Referring to FIG. 1, solar jumpstart system 100 includes, but not limited to, a solar panel 101 and a battery system 102. As shown, solar panel 101 is connected to battery system 102. It is noted that while a solar panel is illustrated, multiple solar panels can be used and the number of solar panels is not limited.

In an embodiment, solar panel 101 may include a number of solar cells or photovoltaic cells (not shown). Through the solar cells, solar panel 101 uses sunlight as a source of energy to generate electricity (e.g., direct current (DC) electricity). In some embodiments, the solar cells can be wafer-based crystalline silicon cells or thin-film cells. In an embodiment, solar panel 101 may be mounted on a roof or another suitable area (e.g., hood or trunk) of a vehicle (e.g., an automobile, such as car, truck, van, bus, autonomous vehicle, etc.) with sunlight exposure. The vehicle can be any type of vehicle, such as an internal combustion engine (ICE) vehicle, an electric vehicle, a hybrid vehicle, etc. Solar panel 101 may also be molded into any specific shape to fit the roof and/or other suitable areas of the vehicle.

With continued reference to FIG. 1, battery system 102 is operable to store or harvest electricity generated by solar panel 101. The electricity (or energy) stored in battery system 102 may be utilized to jumpstart (e.g., providing a boost of power) a vehicle battery (e.g., 12V battery disposed under the hood or inside the trunk of an automobile). Therefore, when the vehicle battery is discharged or depleted, one is not required to find another vehicle or rely on an external power source to jumpstart his/her vehicle. Instead, energy stored in battery system 102 is readily available to perform the jumpstart operation when needed. In an embodiment, battery system 102 may also be utilized to charge or power mobile electronic devices (e.g., smartphones, tablets, laptops, wearable devices such as a smartwatch, etc.), small appliances, among others, for example by routing charging cables or wires from battery system 102 into a vehicle cabin (e.g., through drill holes located on the roof of the vehicle). In an embodiment, battery system 102 may include a number of batteries, and those batteries may include one or more large batteries (e.g., 12V battery) operable to jumpstart a vehicle and one or more smaller batteries (e.g., 6V battery) operable to charge the mobile devices, small appliances, etc. The batteries of battery system 102 may be recharged by solar panel 101, as previously described. In an embodiment, each battery of battery system 102 can be made of a number of materials, for example salt water, citric acid, lead acid, lithium ion, etc. In an embodiment, battery system 102 may be disposed under the hood of a vehicle, inside the trunk of the vehicle, or any suitable location of the vehicle.

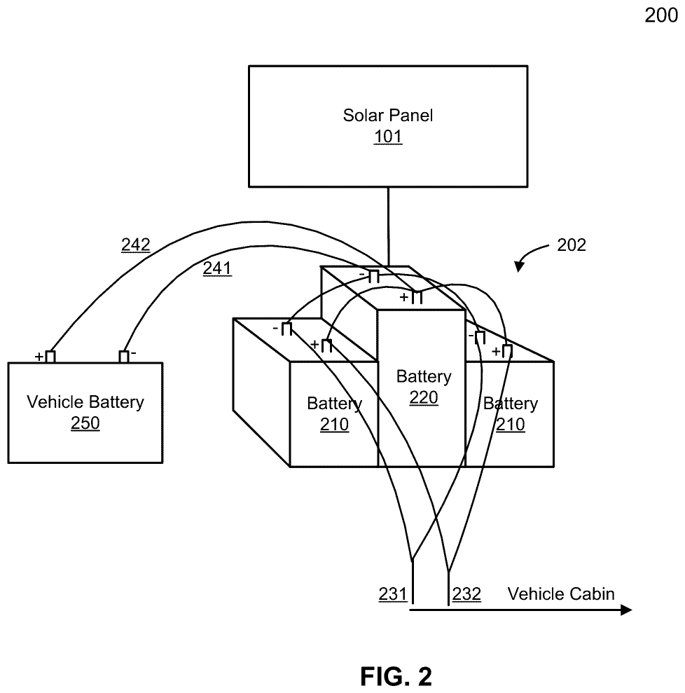

FIG. 2 is a block diagram illustrating another example of the solar jumpstart system according to one embodiment. As shown, solar jumpstart system 200 includes solar panel 101 connected to battery system 202. Aspects of the solar panel 101 have been previously described, and for brevity sake, will not be described again herein. In some embodiments, battery system 202 may be battery system 102 of FIG. 1.

Referring to FIG. 2, battery system 202 includes, but not limited to, a battery 220 (e.g., 12V battery) and a pair of batteries 210 (e.g., 6V batteries), with battery 220 being disposed in between the batteries 210. Note that while FIG. 2 illustrates a battery 220 and a pair of batteries 210, any number of battery 210 and battery 220 can be included in battery system 202. Also, while FIG. 2 illustrates battery 220 being disposed in between batteries 210, one of ordinary skill in the art would appreciate that those batteries can be disposed in any order and at any location, and are not required to be next to one another as illustrated.

With continued reference to FIG. 2, batteries 210 and battery 220 can be connected in parallel with one another. That is, the positive terminals (anodes) of batteries 210-220 are connected together, and similarly, the negative terminals (cathodes) of batteries 210-220 are connected together. As shown, the cathode of battery 220 may be connected to the cathode of a vehicle battery 250 (e.g., 12V battery) via a conductor 241 (e.g., a cable) while the anode of battery 220 may be connected to the anode of the vehicle battery 250 via a conductor 242 (e.g., another cable). Such connections would enable battery system 202 to jumpstart the vehicle battery 250 when it is discharged or depleted.

As an example, when a battery (e.g., vehicle battery 250) of an automobile (e.g., car, truck, van, sport utility vehicle, etc.) is depleted, current may flow from battery 220 to the depleted battery of the automobile, through conductors 241-242, to provide a sufficient boost of power to the depleted battery in order to crank and start the vehicle's engine. Once the engine is running, the alternator of the vehicle would charge the depleted battery. In an embodiment, conductors 241-242 may stay open while the vehicle's engine is running to provide maximum fuel efficiency. In an embodiment, battery system 202 would jumpstart the vehicle battery 250 when battery 220 is fully charged.

As further shown in FIG. 2, the cathodes and anodes of batteries 210 may be connected, through conductors 231-232 respectively, to electronic device charging ports (e.g., universal serial bus (USB) charging ports) located inside a vehicle cabin of a vehicle (e.g., in the front console, center console's front and rear compartments, rear console, etc.). With the power provided by batteries 210, the charging ports may charge or power mobile electronic devices (e.g., smartphones, tablets, laptops, wearable devices such as a smartwatch, etc.), small appliances, among others.

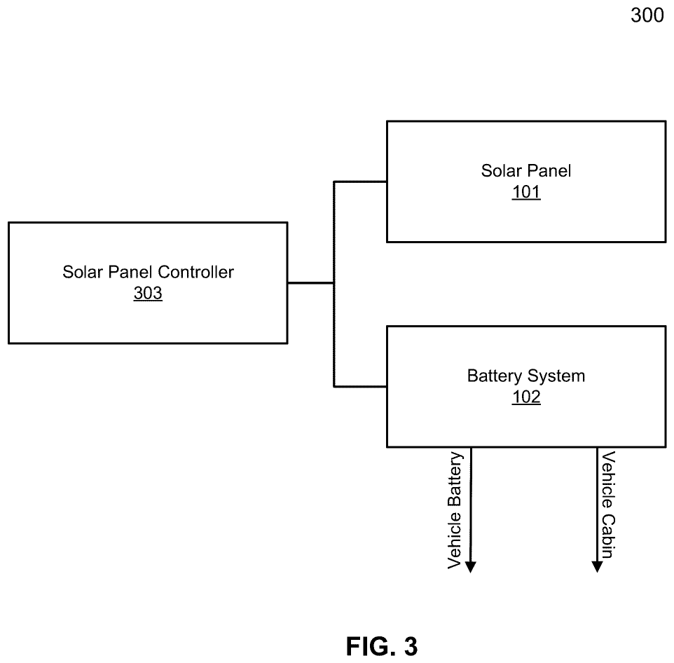

FIG. 3 is a block diagram illustrating yet another example of the solar jumpstart system according to one embodiment. In FIG. 3, solar jumpstart system 300 includes solar panel 101, battery system 102, and solar panel controller 303. System 300 may be similar to system 100 of FIG. 1, but in FIG. 3, solar panel 101 is connected to battery system 102 through solar panel controller 303. Aspects of solar panel 101 and battery system 102 have been previously described, and for brevity sake, will not be described again herein.

In an embodiment, solar panel controller 303 (also referred to as solar charge controller) operates by regulating the voltage and current flow from solar panel 101 to the batteries of battery system 102. Controller 303 may include a DC to AC power inverter. In an embodiment, controller 303 may be disposed at a location near a driver seat of a vehicle. The controller 303 may be wired through holes in the roof or other suitable part of the vehicle. Controller 303 may detect and monitor the battery voltage in order to reduce the current when the batteries are fully charged, thereby efficiently and safely charging the batteries, and preventing overcharging of the batteries. In some embodiments, controller 303 may be a pulse width modulation (PWM) charge controller or maximum power point tracking (MPPT) charge controller.

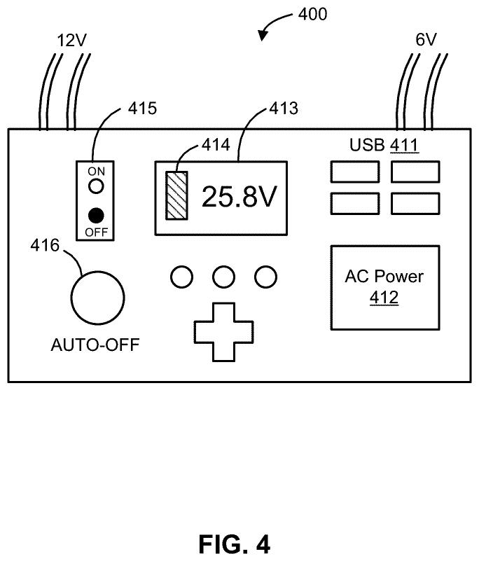

FIG. 4 is a block diagram illustrating an example of a battery system of the solar jumpstart system according to one embodiment. In some embodiments, battery system 400 may be battery system 102 of FIG. 1 or battery system 202 of FIG. 2.

Referring to FIG. 4, system 400 may include, but not limited to, USB ports 411, an AC power outlet 412, a display 413, a jumpstart indicator 415 and a boost controller 416. In an embodiment, components 411-416 of system 400 may be disposed or integrated on a side of a housing that contains system 400. In another embodiment, components 411-416 may be disposed or integrated on a side of a battery of the battery system 400.

With continued reference to FIG. 4, USB ports 411 may be connected to one or more batteries of system 400 (e.g., 6V batteries) to charge or power mobile electronic devices (e.g., smartphones, tablets, laptops, wearable devices such as a smartwatch, etc.). AC power outlet 412 may be operable as a charging or power station to charge or power mobile devices, small appliances, among others. In general, AC power outlet 412 may charge the devices faster than USB ports 411.

In an embodiment, display 413 (e.g., liquid crystal display (LCD), light emitting diode (LED) display, thin film transistor (TFT) LCD, etc.) may display the current voltage of battery system 400. As shown, display 413 may include a battery level indicator 414 visually indicating the state of charge of the batteries of system 400. While not shown in FIG. 4, display 413 may also display error codes, fuel economy, and/or improvements as related to the battery system 400.

In an embodiment, jumpstart indicator 415 may indicate whether jumpstart of a vehicle is currently available. For example, when the batteries of system 400 are fully charged or sufficiently charged such that a jumpstart can be performed, the ON state of indicator 415 may be active (e.g., a light corresponding to the ON state would turn on) to indicate that the jumpstart feature on battery system 400 is available. On the other hand, when the batteries of system 400 is not sufficiently charged such that a jumpstart cannot be performed, the OFF state of indicator 415 may be active (e.g., a light corresponding to the OFF state would turn on) to indicate that the jumpstart feature is unavailable.

In an embodiment, boost controller 416 enables a user to manually control the amount of power (or boost) to provide to a depleted vehicle battery through the 12V lines. If the battery is sufficiently or fully charged, the boost controller 416 may automatically be deactivated (i.e., turned off). As shown in FIG. 4, the 12V lines of system 400 may be connected to a vehicle battery while the 6V lines of system 400 may be fed into a vehicle cabin (e.g., through drill holes located on the roof of a vehicle) and connected to electronic device charging ports.

In various embodiments, the solar jumpstart system (as described above) can improve gas mileage of a vehicle and reduce carbon dioxide (CO₂) emission. The solar jumpstart system described herein can also increase alternator efficiency in a vehicle (e.g., increase the alternator voltage by about 2V), thereby reducing fuel consumption. For an electric or hybrid vehicle having one or many electric motors, the use of the system with the vehicle can dramatically increase the vehicle's range, as the vehicle will have extra charging power when it is exposed to sunlight (e.g., while driving or parking). The system can also reduce the need to find charging stations along a route and can further increase gas mileage in hybridized vehicles.

In the foregoing specification, embodiments of the invention have been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. A solar jumpstart system for a vehicle, the solar jumpstart system comprising:
at least one solar panel on the vehicle, the at least one solar panel operable to convert light into electricity; and
a battery system including a plurality of batteries operable to store the electricity generated by the at least one solar panel, wherein the plurality of batteries comprise at least one first battery operable to jumpstart a battery of the vehicle when the battery of the vehicle is depleted or discharged.

2. The solar jumpstart system of claim 1, wherein the plurality of batteries further comprise at least one second battery operable to charge electronic devices and small appliances.

3. The solar jumpstart system of claim 2, wherein the at least one first battery and the at least one second battery are connected in parallel with one another.

4. The solar jumpstart system of claim 1, wherein the at least one first battery is connected in parallel with the battery of the vehicle.

5. The solar jumpstart system of claim 1, further comprising:
a solar charge controller operable to connect the at least one solar panel to the battery system, and to regulate voltage and current flow from the at least one solar panel to the batteries of battery system.

6. The solar jumpstart system of claim 5, wherein the solar charge controller is a pulse width modulation (PWM) charge controller or maximum power point tracking (MPPT) charge controller.

7. The solar jumpstart system of claim 1, wherein the plurality of batteries further comprise at least one second battery connected to electronic device charging ports of the vehicle through one or more conductors.

8. The solar jumpstart system of claim 7, wherein the one or more conductors are fed into a cabin of the vehicle.

9. The solar jumpstart system of claim 8, wherein the one or more conductors are fed into the cabin of the vehicle through holes located on a roof of the vehicle.

10. The solar jumpstart system of claim 1, wherein the at least one first battery is a 12V battery.

11. The solar jumpstart system of claim 2, wherein the at least one second battery is a 6V battery.

12. The solar jumpstart system of claim 1, wherein the battery system further includes a plurality of universal serial bus (USB) ports to charge or power electronic devices.

13. The solar jumpstart system of claim 1, wherein the battery system further includes an AC power outlet operable as a charging or power station.

14. The solar jumpstart system of claim 1, wherein the battery system further includes a display displaying a voltage of the battery system.

15. The solar jumpstart system of claim 14, wherein the display includes a battery level indicator visually indicating state of charge of the battery system.

16. The solar jumpstart system of claim 1, wherein the battery system further includes a jumpstart indicator indicating whether the jumpstart of the battery of the vehicle is available.

17. The solar jumpstart system of claim 1, wherein the at least one first battery only performs the jumpstart of the battery of the vehicle when the at least one first battery is fully charged by the at least one solar panel.
